(19) United States
(12) Patent Application Publication
(10) Pub. No.: US 2011/0093543 A1
(43) Pub. Date: Apr. 21, 2011

(54) MESSAGE SERVER DEVICE AND METHOD FOR CONTROLLING MESSAGE DELIVERY

(76) Inventors: Stuart O. Goldman, Scottsdale, AZ (US); Anil P. Macwan, Naperville, IL (US)

(21) Appl. No.: 12/581,928

(22) Filed: Oct. 20, 2009

(51) Int. Cl. G06F 15/16

(52) U.S. Cl. 709/206; 455/466

(57) ABSTRACT

An exemplary method of controlling message delivery includes receiving a message from a user at a message server. A determination is made whether the message requires a user-specified delivery criterion to be met prior to delivery of the message. The message is sent to an intended recipient if the message does not require the user-specified delivery criterion. The message is held in a specified delivery buffer if the message does require that the user-specified delivery criterion be met. The message from the specified delivery buffer will be automatically sent on behalf of the user to the intended recipient responsive to the user-specified delivery criterion being met.

### 1. FIELD OF THE INVENTION

This invention generally relates to communication. More particularly, this invention relates to controlling message delivery.

### 2. DESCRIPTION OF THE RELATED ART

A variety of communication techniques are in widespread use today. More communication forms exist today than ever before. For example, individual users may communicate with others using voice communication, electronic mail (email) messages, short message service (e.g., texting) messages, facsimile transmissions or a combination of these. Various technological developments have given rise to an increased use of non-voice communications such that messaging is becoming increasingly popular and increasingly important.

A variety of features are available to users for sending email communications and other types of messages. With the increased availability of access to such communications, users are becoming more dependent on them and more demanding of enhanced services from service providers.

### SUMMARY

An exemplary method of controlling message delivery includes receiving a message from a user at a message server. A determination is made whether the message requires a user-specified delivery criterion to be met prior to delivery of the message. The message is sent to an intended recipient if the message does not require the user-specified delivery criterion. The message is held in a specified delivery buffer if the message does require that the user-specified delivery criterion be met. The message from the specified delivery buffer will be automatically sent on behalf of the user to the intended recipient responsive to the user-specified delivery criterion being met.

An exemplary message server device includes a receiver portion configured to receive a message from a user. A message filter is configured to determine if the message requires a user-specified delivery criterion to be met prior to the delivery of the message. A transmitter portion is configured to send the message to an intended recipient if the message does not require the user-specified delivery criterion. A specified delivery buffer is configured to hold the message if the message does require the user-specified delivery criterion to be met. The transmitter portion will automatically send a message from the specified delivery buffer on behalf of the user to the intended recipient responsive to the user-specified delivery criterion being met.

The various features and advantages of disclosed examples will become apparent to those skilled in the art from the following detailed description.

The drawings that accompany the detailed description can be briefly described as follows.

### BRIEF DESCRIPTION OF THE DRAWINGS

FIG. 1 schematically illustrates selected portions of a communication arrangement designed according to an embodiment of this invention.

FIG. 2 is a flowchart diagram summarizing one example approach.

### DETAILED DESCRIPTION

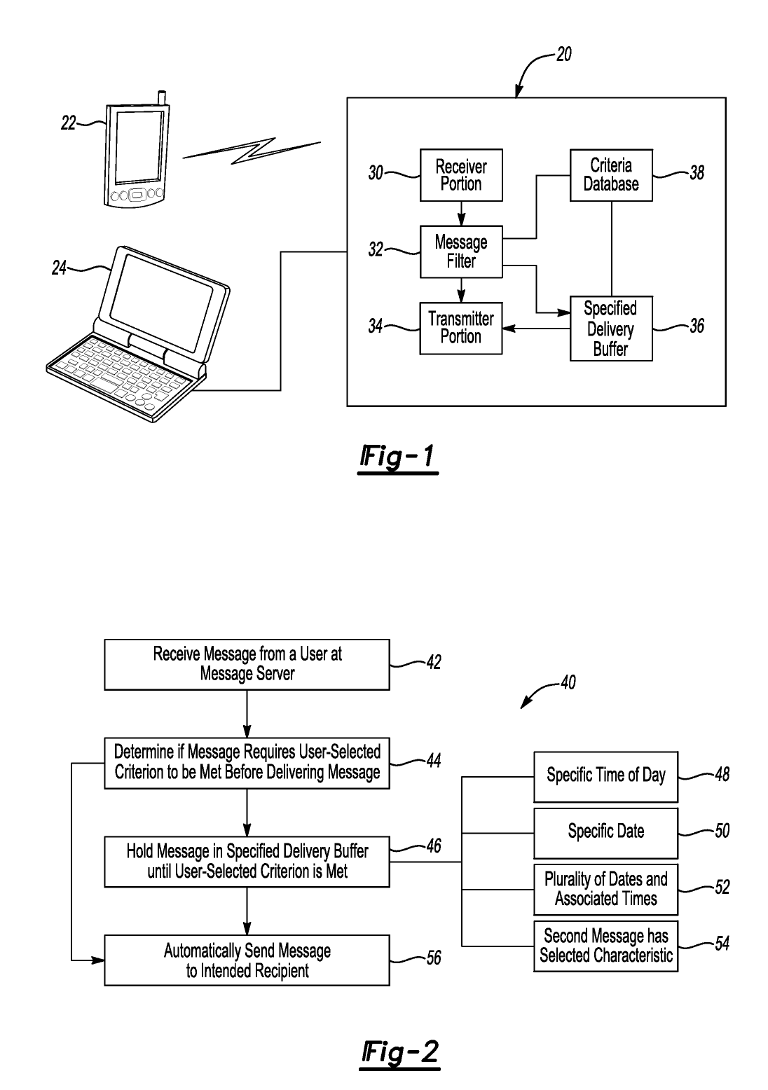

FIG. 1 schematically shows a message server device 20 that controls message delivery on behalf of a user. FIG. 1 shows example user devices 22 and 24 that communicate with the message server device 20. In this example, the user device 22 comprises a mobile station that communicates wirelessly with the message server 20. The user device 24 in this example comprises a device that can alternatively communicate with the message server 20 over a line-based connection or using wireless communication capabilities.

The server device 20 provides the user with the ability to set specified criteria that will control the delivery of a message from that user to an intended recipient. The example server device 20 includes a receiver portion 30 that is configured to receive one or more message from one or more users. A message filter 32 is configured to determine whether a message received from a user requires at least one user-specified delivery criterion to be met prior to delivery of that message. In one example, the message filter 32 detects whether the user has set a flag or otherwise provided an indication associated with a message that indicates that specified delivery criteria are required before the message is to be sent to an intended recipient. In another example, the message filter 32 determines whether a message received by the receiver portion 30 has at least one selected characteristic that indicates that it is only to be delivered upon the satisfaction of at least one user-specified criterion.

The message server device 20 includes a transmitter portion 34 configured to send messages to intended recipients. In the event that the message filter 32 determines that a particular message from a user does not have any specified delivery limitations, the message filter 32 passes the message to the transmitter portion 34 from which it is sent to an intended recipient or recipients, depending on the user's preference. In the event that the message is not to be delivered until a specified criterion is satisfied, the message filter 32 passes the message to a specified delivery buffer 36. The message will be held in the specified delivery buffer 36 until the user-specified criterion is satisfied. The example server device 20 includes a criteria database 38 that stores a variety of criteria information for a plurality of users so that different users can set different limitations on the delivery of a variety of messages to meet their particular needs.

FIG. 2 includes a flow chart diagram 40 that summarizes one example approach. At 42 a message is received from a user at the message server device 20. At 44 the determination is made if the message requires at least one user-specified criterion to be met before delivering the message. If any criteria must be met before the message is delivered, the message is held at 46 in a specified delivery buffer until the appropriate criterion is met.

The example of FIG. 2 includes several criteria that may be used alone or in combination to control when one or more messages is sent on behalf of a user from the transmitter portion 34. In this example, one criterion at 48 comprises a specific time of day. This allows a user to specify that a message be delivered at a particular time of day. One feature of the disclosed example is that the user device 22, 24 need not be connected with the server device 20 or a network associated with the server device 20 at the specified time of day. Instead, the message being held in the specified delivery buffer 36 allows for the server device 20 to send a message at the time specified by the user regardless of the status of the user or the user's device from which the message was received.

Another example criterion is shown at 50 that comprises a specific date. Date and time information can be combined to deliver messages to particular intended recipients to meet specific timing requirements. For example, a delivery message may be delivered at a specific time of day on the intended recipient's birthday. This allows a user to have the message delivered at their discretion regardless of any difference in time zone between the user's location and the intended recipient's location and does not require the user to be actively communicating with the servicer device 20 or an associated network at the specified delivery time.

Another example criterion is shown at 52 that comprises a plurality of dates and associated times. This feature allows a user to specify that a particular message will be delivered multiple times to one or more intended recipients on a particular schedule. This may be useful, for example, in a business setting where a reminder is sent out to individuals in a work group regarding periodic due dates. The message from the specified delivery buffer will be delivered according to the criteria at one of the specified times while also being held in the specified delivery buffer so that the message can again be delivered at a subsequent one of the specified times. In one example, a user provides an indication with the message that indicates the criteria and the message filter 32, the specified delivery buffer 36 or both determines how the message is to be handled within the buffer to ensure that multiple deliveries at various times are accomplished according to the user's desires.

Another example criterion is shown at 54 which comprises a second message having at least one selected characteristic that serves as a trigger for delivering the message from the specified delivery buffer 36. In one example, a user indicates that a particular message from the user should be delivered to an intended recipient upon receipt of a second message. The second message or the sender of the second message has at least one selected characteristic. This is useful, for example, in sending a message to a customer when payment is received by a seller. A seller may generate a confirmation message that payment has been received and send that to the message server device 20. With appropriate indications, the specified delivery buffer 36 will hold that message until another message is received by the server device 20 indicating that payment has been made. That message may come from a payment service that the original user or seller utilizes or that message may come from the seller. Either way, the second message serves as a trigger to instigate automatic delivery of that message from the specified delivery buffer through the transmitter portion 34.

At 56 the message is automatically sent to the intended recipient or plurality of recipients.

In the event that the message does not require any user-selected criterion to be met before it is delivered, it is automatically sent to the intended recipient without being held in the specified delivery buffer.

The message format of the messages delivered by the message service device 20 may be an email communication message, a short message service communication message, recorded audio, recorded video or digitally stored data.

The preceding description is exemplary rather than limiting in nature. Variations and modifications to the disclosed examples may become apparent to those skilled in the art that do not necessarily depart from the scope of legal protection given to this invention, which can only be determined by studying the following claims.

We claim:

1. A method of controlling message delivery, comprising the steps of:
receiving a message from a user at a message server;
determining if the message requires a user-specified delivery criterion to be met prior to delivery of the message;
sending the message to an intended recipient if the message does not require the user-specified delivery criterion;
holding the message in a specified delivery buffer if the message does require the user-specified delivery criterion to be met; and
automatically sending the message from the specified delivery buffer on behalf of the user to the intended recipient responsive to the user-specified delivery criterion being met.

2. The method of claim 1, wherein the user-specified delivery criterion comprises a specified time of day.

3. The method of claim 2, wherein the user-specified delivery criterion comprises a calendar day.

4. The method of claim 3, comprising automatically sending the message from the specified delivery buffer to a plurality of intended recipients responsive to the user-specified delivery criterion being met.

5. The method of claim 1, wherein the user-specified delivery criterion comprises a plurality of selected dates and associated times and the method comprises automatically sending the message from the specified delivery buffer on behalf of the user on each of the selected dates at the associated times.

6. The method of claim 5, comprising automatically sending the message from the specified delivery buffer to a plurality of intended recipients responsive to the user-specified delivery criterion being met.

7. The method of claim 1, wherein the user-specified delivery criterion comprises a second message being received at the message server that has at least one specified characteristic and the message from the specified delivery buffer is automatically sent to the intended recipient responsive to the second message having the at least one specified characteristic.

8. The method of claim 7, wherein the second message is at least one of from the user or intended for the user.

9. The method of claim 1, wherein the message comprises at least one of a short message service communication or an electronic mail communication.

10. The method of claim 1, wherein the message comprises at least one of recorded voice, recorded video or digitally stored data.

11. A message server device, comprising:
a receiver portion configured to receive a message from a user;
a message filter configured to determine if the message requires a user-specified delivery criterion to be met prior to delivery of the message;
a transmitter portion configured to send the message to an intended recipient if the message does not require the user-specified delivery criterion;
a specified delivery buffer configured to hold the message if the message does require the user-specified delivery criterion to be met; and
wherein the transmitter portion is configured to automatically send the message from the specified delivery buffer on behalf of the user to the intended recipient responsive to the user-specified delivery criterion being met.

12. The device of claim 11, wherein the user-specified delivery criterion comprises a specified time of day.

13. The device of claim 12, wherein the user-specified delivery criterion comprises a calendar day.

14. The device of claim 13, wherein the transmitter portion is configured to automatically send the message from the specified delivery buffer to a plurality of intended recipients responsive to the user-specified delivery criterion being met.

15. The device of claim 11, wherein the user-specified delivery criterion comprises a plurality of selected dates and associated times and the transmitter portion is configured to automatically send the message from the specified delivery buffer on behalf of the user on each of the selected dates at the associated times.

16. The device of claim 15, wherein the transmitter portion is configured to automatically send the message from the specified delivery buffer to a plurality of intended recipients responsive to the user-specified delivery criterion being met.

17. The device of claim 11, wherein
the user-specified delivery criterion comprises a second message being received at the message server that has at least one specified characteristic and
the transmitter portion is configured to automatically send the message from the specified delivery buffer to the intended recipient responsive to the second message having the at least one specified characteristic.

18. The device of claim 17, wherein the second message is at least one of from the user or intended for the user.

19. The device of claim 11, wherein the message comprises at least one of a short message service communication or an electronic mail communication.

20. The device of claim 11, wherein the message comprises at least one of recorded voice, recorded video or digitally stored data.
